(19) United States
(12) Patent Application Publication
(10) Pub. No.: US 2005/0044773 A1
(43) Pub. Date: Mar. 3, 2005

(54) Chum tube lure

(76) Inventors: Richard Andrew Schelle, Plymouth, MA (US); James Edward Murhaghan, Plymouth, MA (US); Jeffrey Bruce Nelson, Plymouth, MA (US); David John South, Plymouth, MA (US)

Correspondence Address: Richard A. Schelle, P O Box 887, Plymouth, MA, 02362, US

(21) Appl. No.: 10/647,178

(22) Filed: Aug. 25, 2003

(51) Int. Cl. A01K 97/02

(52) U.S. Cl. 43/44.99

(57) ABSTRACT

A Chum Tube Lure designed for catching fish by spreading a chum slick or fish oil attractant out the back of a chum tube and over the lure. Chum or fish oil attractant is inserted into the head of the chum tube and fills the inside of the tube. Inside the tube is a piece of manila rope used to absorb the fish oil and slow the process of spreading the chum slick or fish oil out and over the lure. As the Chum Tube Lure is trolled through the water, water flows through the head at the front of the chum tube forcing the fish oil out the back of the chum tube and over the lure. The Chum Tube Lure such as a chum tube eel is a tube eel attached to the back section of the chum tube. The chum tube eel or lure is spinning around creating noise and vibrations in the water. This accompanied by the fish oil attractant flowing over the lure helps to attract fish to the lure.

### BACKGROUND OF THE INVENTION

This invention relates to fishing lures and in particular to a method and apparatus for the controlled release of a chum slick or fish oil attractant over the fishing lure being trolled. The loading, holding and controlled release of the chum slick or fish oil attractant is not part of the fishing lure, it is the chum tube in front of the fishing lure. The fishing lure is attached to the chum tube with a barrel swivel causing the lure to rotate when trolled with a chum slick or fish oil attractant flowing over the lure.

A fishing lure as described in U.S. Pat. No. 5,155,947, issued Oct. 20, 1992 to David J. Rivard, is one in which the fishing lure has an internal cavity into which fish attractant is introduced through an entry aperture. When the lure is being trolled, water enters through the entry aperture, flows through the internal cavity and disperses out through an exit aperture flushing out a small amount of fish attractant with it. A baffle located within the internal cavity controls flushing of the fish attractant.

In the prior art the fishing lure was used to load, hold and release the fish attractant. This limited the fisherman to one lure, where on many days depending on time of day, water temperature and fishing depth some lures work and others do not. Even with the fish attractant there is no guarantee a particular lure will work under all circumstances.

### SUMMARY OF THE INVENTION

In accordance with the present invention a Chum Tube Lure apparatus and method is provided for catching fish by line and reel. The Chum Tube Lure is comprised of a chum tube and lure with means for distributing chum or fish oil over the lure to attract fish. The chum tube is attached to the lure using a barrel swivel to allow the lure to rotate independent of the chum tube. The head of the chum tube has an eye at the top, to attach the Chum Tube Lure to line and reel for trolling the Chum Tube Lure through the water. The eye at the top of the chum tube head aids in trolling the chum tube upright while the lure attached with a barrel swivel is allowed to rotate freely. The chum tube head has a hole at the bottom of the head just below the eye and is angled up to the center of the head at the back end. The hole is for loading the chum or fish oil into the chum tube. When the Chum Tube Lure is trolled, the hole allows water to flow through the chum tube distributing the fish oil or attractant out the back of the chum tube over the lure to attract fish. The hole in the lead head angled up allows the chum tube lure to be trolled deeper.

In accordance with a further feature of the invention a manila rope comprises means to control the release of the fish attractant. A three-inch long piece of manila rope floats inside the chum tube. The manila rope is used to absorb the fish oil and slow or control the process of spreading the chum slick or fish oil attractant.

In accordance with a further feature of the invention a ¾-inch long piece of dowel comprises means to plug the back end of the chum tube for holding the fish oil attractant. A hole through the dowel is offset from the center of the dowel to aid the manila rope in release of the fish oil attractant from the chum tube and to aid the barrel swivel in rotating the lure erratically to attract fish.

The wire line from the chum tube connects to one end of a barrel swivel and the other end to the lure. Water flows through the chum tube releasing the fish attractant over and around the lure to simulate live bait.

In accordance with a further feature of the invention a hole in the head of the chum tube is angled to provide a deeper dive and trolling depth. The trolling depth is also controlled by the weight of the head and type of line attached to the reel i.e. wire line, lead line or monofilament line.

### BRIEF DESCRIPTION OF THE DRAWINGS

Other and further features of the invention will become apparent in connection with the accompanying photos wherein:

FIG. 1 is a photo illustrating a line and reel fishing system embodying the Chum Tube Lure invention;

FIG. 2 is a photo illustrating a partial assembled chum tube comprising a lead head, manila rope, wood dowel, wire, wire chimps, barrel swivel and tube;

FIG. 3 is a photo illustrating a side view of the lead head;

FIG. 4 is a photo illustrating a top view of the lead head;

FIG. 5 is a photo illustrating a bottom view of the lead head;

FIG. 6 is a photo illustrating the three-inch long piece of manila rope;

FIG. 7 is a photo illustrating a ¾ inch wood dowel with an offset hole;

FIG. 8 is a photo illustrating a partial assembled tube eel comprising wood dowel, wire, wire chimps, barrel swivel, tube and fishhook;

### DESCRIPTION OF THE PREFERRED EMBODIMENT

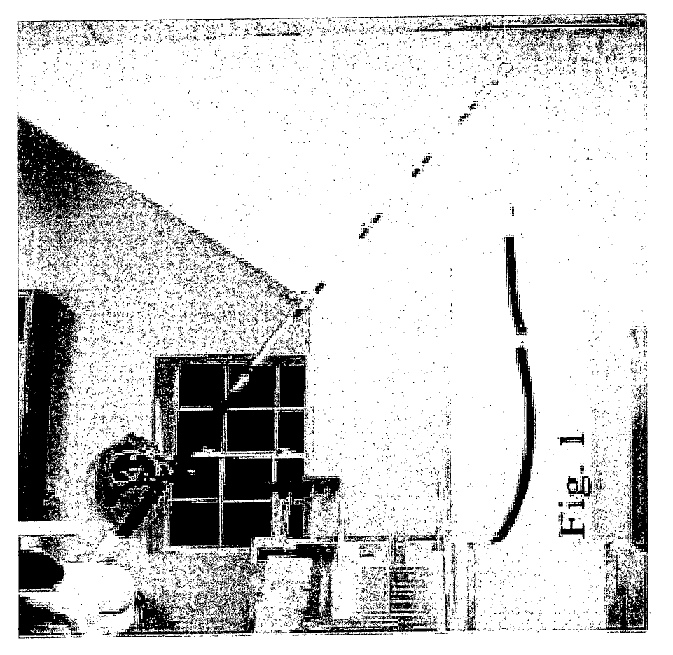

Referring now to FIG. 1, there is a photo illustrating a line and reel fishing system embodying the Chum Tube Lure. The Chum Tube Lure is comprised of a chum tube with a tube eel as a lure attached. When the Chum Tube Eel is trolled, the hole at the bottom and front of the chum tube lead head allows water to flow through the chum tube distributing the fish oil attractant out the back of the chum tube and over the tube eel or lure to attract fish. A piece of manila rope floats inside the chum tube to absorb the fish oil to slow or control the process of spreading the fish oil attractant. A piece of wood dowel with a hole offset from the center is used to seal the back end of the chum tube and allows the wire lie from the lead head to be used to attach the lure and also control the release of the fish oil attractant. The hole in the lead head angled up front to back forces a deeper dive when trolled through the water. The hole in the lead head is also used to load the chum tube with fish oil attractant. Line from the reel is attached to the eye on the front and top of the chum tube lead head by tying the line directly or by a wire snap attached to the line from the reel. The eye at the top of the head also aids in trolling the chum tube though the water to release the fish oil attractant with out having the chum tube rotate. The wire line from the chum tube is attached to the wire line from the tube eel with a barrel swivel for a Chum Tube Lure. The wire line from the Chum Tube is crimped to one end the barrel swivel and the other end crimped to the wire from the tube eel. The barrel swivel allows the tube eel to rotate when trolled through the water. A piece of wood dowel with a hole offset from the center is also used to seal the front end of the tube eel. The wood dowels with offset holes cause the tube eel lure to swing erratically simulating a wounded eel or fish.

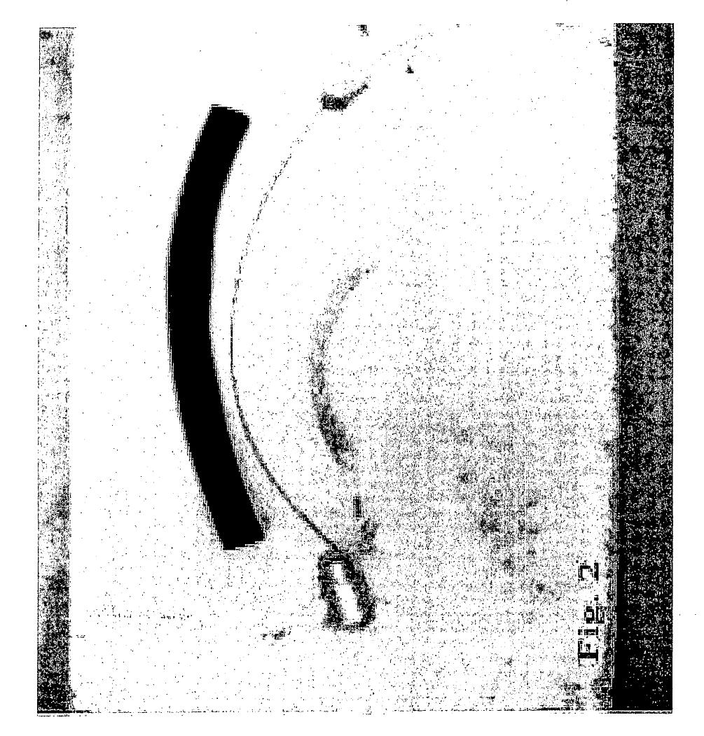

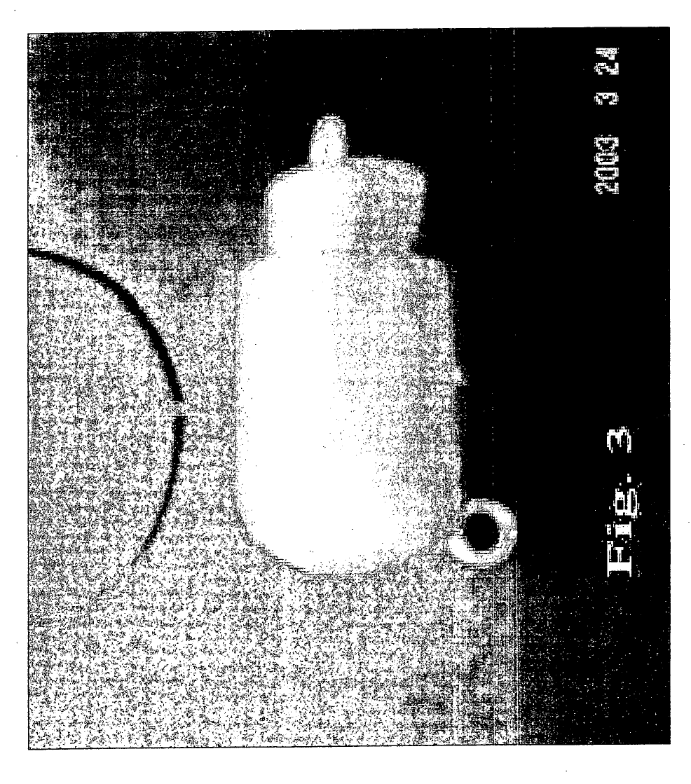

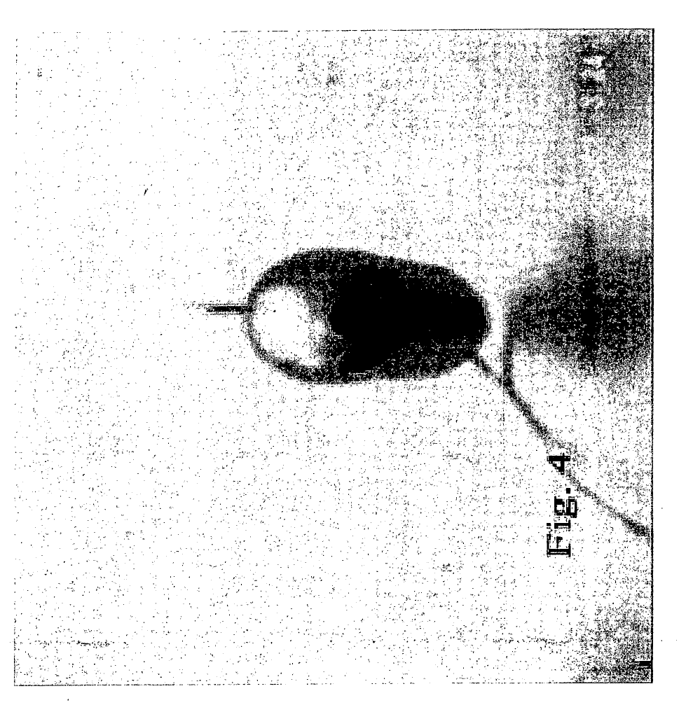

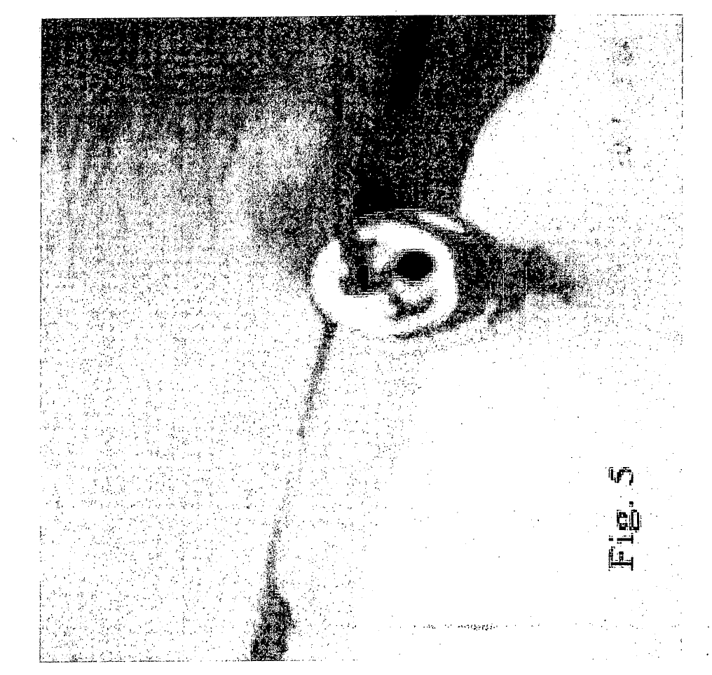

Referring now to FIG. 2, a photo of a partially assembled chum tube shown comprising the components that make up a Chum Tube. Views of the lead head shown in FIG. 2 are also shown in FIGS. 3, 4 and 5. Features of the lead head show the hole for loading and distributing the fish oil attractant, the hole angled up front to back forces a deeper dive, and the two eyes one to attach the fishing line and the other to attach the wire line that runs through the tube to the lure.

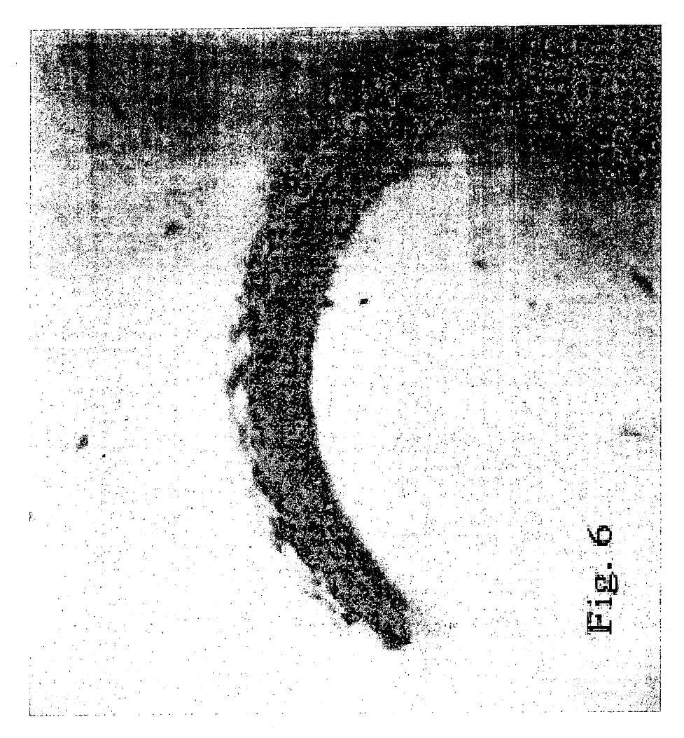

Still referring to FIG. 2 the view of the manila rope is also shown in FIG. 6. When the chum tube is assembled the three-inch long piece of manila rope is not attached, it floats inside the chum tube. The manila rope absorbs some of the fish oil and the rest is used to fill the chum tube. The manila rope is used for a controlled release of the fish oil over a longer period of time.

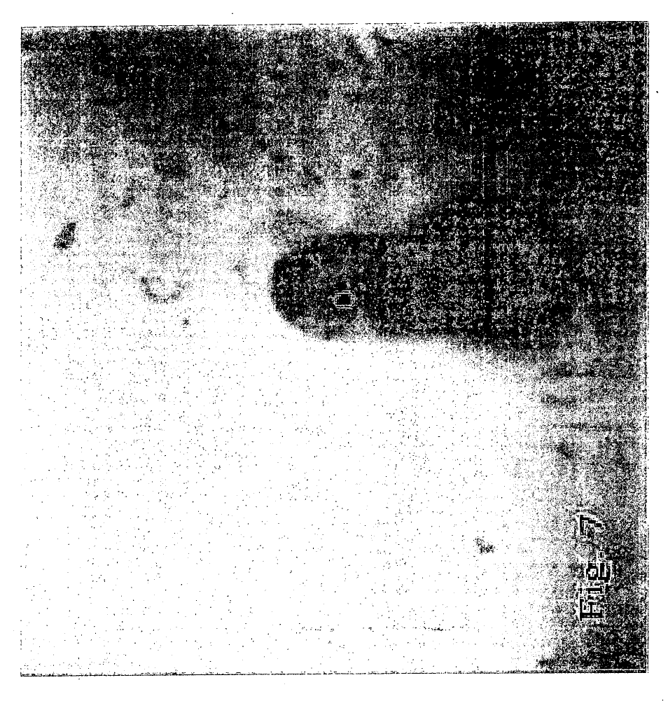

Still referring to FIG. 2 the view of the wood dowel, tube, wire and barrel swivel are also shown in FIG. 7. The ¾ inch long piece of wood dowel is used to seal the back end of the chum tube holding the fish oil inside the tube. A hole in the wood dowel and the manila rope control the release of the fish oil. A wire line from the lead head is routed through the tube and wood dowel to connect to one end of a barrel swivel. The other end of the barrel swivel connects to the lure. The hole in the wood dowel is offset from the center of the dowel to aid in rotating the lure erratically.

Still referring to FIG. 2 the view of the lead head, wire and crimp. The wire is threaded through the eye at the bottom and rear of the lead head twisted over and crimped. This crimp has the same breaking strength as the wire.

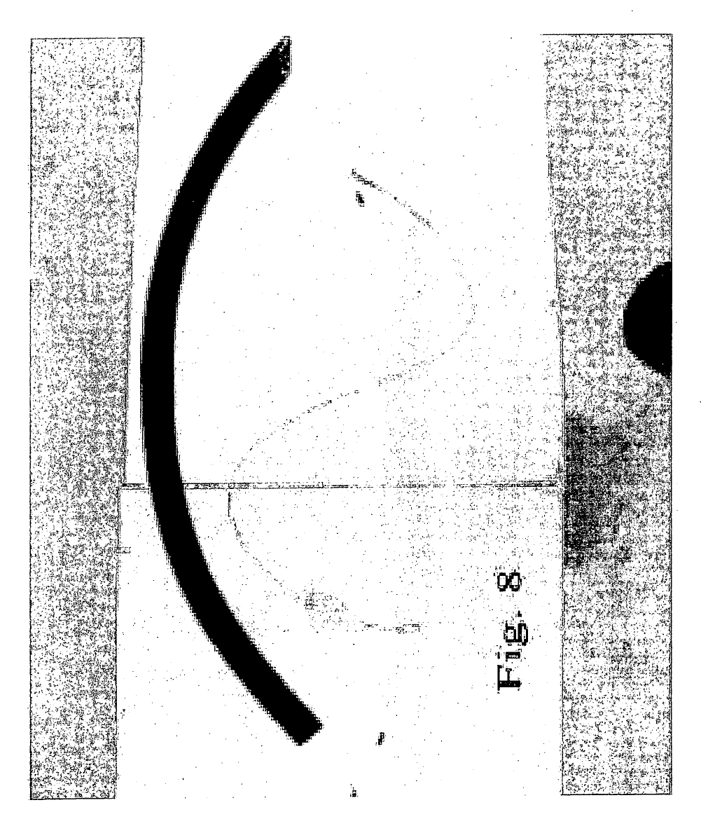

Referring now to FIG. 8, a photo of a partially assembled eel tube. The wire at back end is crimped to a fishhook and threaded through the tube. At the other end a wood dowel with a hole offset from the center is used to seal the front end of the eel tube. The wire from the front end is crimped to one end of a barrel swivel and the other end is crimped to the wire from the chum tube. The chum tube and eel tube make a Chum Tube Lure.

This concludes the description of the preferred embodiment. However, many modifications and alterations will be obvious to one of ordinary skill in the art without departing from the spirit and scope of the inventive concept. For example a chum tube can be used with a second wood dowel in place of the lead head for the lightest chum tube. A barrel snap can be used in place of the eye on the top front of the lead head and the fish oil attractant loaded through the hole in the second wood dowel. The barrel swivel at the back end of the chum tube is used to attach the lure. Therefore, it is intended that the scope of this invention be limited only by the appended claims.

1. A line and reel fishing system Chum Tube Lure comprising:
chum tube means to load and hold fish oil attractant for a controlled release of the fish oil attractant;
means, coupled to said chum tube means for trolling deeper;
means, coupled to output of said chum tube means for rotating the lure and receiving fish oil attractant over the lure.

2. The line and reel fishing system Chum Tube Lure as recited in claim 1 wherein:
said chum tube means comprises lead head means with a hole for loading fish oil attractant.

3. The line and reel fishing system Chum Tube Lure as recited in claim 2 wherein:
said lead head means with said hole angled up from the front to back provides a deeper depth at which the Chum Tube Lure is trolled.

4. The line and reel fishing system Chum Tube Lure as recited in claim 2 wherein:
said lead head means comprises an eye at the front and top to keep said chum tube means upright when trolled.

5. The line and reel fishing system Chum Tube Lure as recited in claim 1 wherein:
said chum tube means comprises three-inch long piece of manila rope to absorb and control the release of the fish oil attractant.

6. The line and reel fishing system Chum Tube Lure as recited in claim 1 wherein:
said chum tube means comprises a ¾ inch wood dowel with an offset hole to seal the back end of the chum tube and also controls the release of the fish oil attractant.

7. The line and reel fishing system Chum Tube Lure as recited in claim 2 wherein:
said wood dowel means with the offset hole cause said lure to swing erratically.

8. The line and reel fishing system Chum Tube Lure as recited in claim 1 wherein:
said lure means comprises a barrel swivel for rotating the said lure.
